(19) United States
(12) Patent Application Publication
(10) Pub. No.: US 2014/0212467 A1
(43) Pub. Date: Jul. 31, 2014

(54) Antimicrobial Composite Material

(71) Applicant: CORNING INCORPORATED, Corning, NY (US)

(72) Inventors: Guohua Chen, Painted Post, NY (US); Dayue Jiang, Painted Post, NY (US); Joydeep Lahiri, Painted Post, NY (US); Florence Verrier, Corning, NY (US); Jianguo Wang, Horseheads, NY (US); Ying Wei, Painted Post, NY (US)

(21) Appl. No.: 14/342,615

(22) PCT Filed: Sep. 7, 2012
(86) PCT No.: PCT/US2012/054126

§ 371 Date: Apr. 8, 2014

Related U.S. Application Data
(60) Provisional application No. 61/532,399, filed on Sep. 8, 2011.

(51) Int. Cl. A01N 59/20; A01N 25/34

(52) U.S. Cl. CPC A01N 59/20; A01N 25/34
USPC 424/411; 424/405; 424/630

(57) ABSTRACT

The present disclosure is directed to an antimicrobial composite material, and more particularly to an antimicrobial composite material comprising particles having a metal or metal alloy core and a porous inorganic material shell, coatings including the antimicrobial composite material, and methods of making the same. In some embodiments, Cu—SiO₂ core-shell particles are disclosed in which the Cu core provides antimicrobial activity and the porous SiO₂ shell functions as a barrier for the Cu core, thus preventing the Cu core from being directly exposed to air or moisture.

This application claims the benefit of priority under 35 U.S.C. §119 of U.S. Provisional Application Ser. No. 61/532,399 filed Sep. 8, 2011 the content of which is relied upon and incorporated herein by reference in its entirety.

### FIELD

The present disclosure relates to an antimicrobial composite material, and more particularly to an antimicrobial composite material comprising particles having a metal or metal alloy core and a porous inorganic material shell, coatings including the antimicrobial composite material, and methods of making the same.

### BACKGROUND

In many places, for example public places such as hospitals, libraries and banks to name a few, there is a great need for antimicrobial materials, particularly antimicrobial coatings on surfaces, to help prevent the spread of diseases, typically by helping to prevent viruses or bacteria from harboring and spreading from one person to another. Copper and silver are two antimicrobial metals that have been used for years. Copper, Cu, has been officially been approved by the U.S. Environmental Protection Agency (EPA) as an antimicrobial material since 2008.

In recent years much effort has been made efforts to develop methods and processes of making Cu-based materials, including Cu-based alloys, for anti-microbial application. However, many Cu-based antimicrobial materials face two big technical challenges which are (1) low antimicrobial activity and (2) low lifetime of the antimicrobial activity. Known Cu-based antimicrobial materials exhibit low antimicrobial activity because in most cases the materials that contain active Cu contain it in a manner that does not readily enable contact between the copper and the bacteria or viruses. Such contact is necessary to enable the copper, or copper ions derived from the copper, to enter into the bacterium or virus. One example of a Cu-based inorganic material is a copper-containing glass where the Cu is incorporated into glass matrix through a melt process, the active Cu component being sealed-in by the glass.

In a different example of copper in a hydrophobic polymer matrix, the Cu particles in the hydrophobic polymer matrix are often covered by hydrophobic portion because of its low surface energy. As a result, the copper-containing material has low antimicrobial activity. Losing the antimicrobial activity after a short period of time is also a problem. Copper-containing materials can lose activity because of their constant exposure to moisture and air and oxidation. For example, while freshly prepared Cu (0) particles exhibit a high initial antimicrobial activity, they quickly lose this antimicrobial functionality because of oxidation of Cu⁰ to Cu²⁺ which has a minimal antimicrobial functionality. When Cu particles, for example, are applied or embedded into a hydrophilic polymer, the Cu particles likewise readily lose activity because the hydrophilic polymer absorbs the moisture and also because O₂, which can diffuse into a polymer matrix, can also be oxidized to Cu⁺² ions. Although the reduction in activity is lower than that when the particles are not in any material, the reduction in activity can still be significant. Another reason for copper's reduced antimicrobial activity lifetime is that the loss is not kinetically controlled. That is, the kinetics may have initial burst release of the Cu or loss at a very fast rate leading to depletion of the Cu species.

### SUMMARY

The present disclosure is directed to an antimicrobial composite material, and more particularly to an antimicrobial composite material comprising particles having a metal or metal alloy core and a porous inorganic material shell, coatings including the antimicrobial composite material, and methods of making the same. In some embodiments, an antimicrobial polymer-Cu composite is disclosed that allows for a surface reconstruction which provides both high and a long term antimicrobial activity/capability through a doubly controlled slow release of the active Cu particles, and to a method for making such composite. The first slowly controlled releasing mechanism is accomplished by the structure of the Cu particles that were designed and synthesized into a core-shell structure. For example, Cu—SiO₂ core-shell particles were prepared in which the Cu core provides the antimicrobially active material and a porous SiO₂ shell functions as a barrier for the Cu core—preventing the Cu core from being directly exposed to the air/moisture without affecting the activity of the Cu core.

The second slowly controlled releasing mechanism is accomplished by using a polymer matrix that in one embodiment is an amphiphilic polymer; that is a polymer that was and “on/off” material having both hydrophilic or “water loving” properties (“on”) and hydrophobic or “water hating” properties “off”). Driven by a polymer-air interaction in dry state, the low surface energy hydrophobic portion enriches on the coating surface (the ‘off’ stage) and hence provides a good protection for Cu particles inside the polymer from being directly exposed to air and moisture.

However, when exposed to moisture/water, the hydrophilic portion of the coating, because of interacting with water that makes a surface reconstruction, is being pulled onto the surface (the ‘on’ stage), and this enables the Cu particles that are being exposed to viruses/bacteria to function. Another mechanism by which the amphiphilic polymer is active is the inherent hydration of hydrophilic moiety, but which is not the large amount of water present in a purely hydrophilic matrix which can lead to accelerated depletion of the Cu.

One embodiment is an antimicrobial composite material comprising a plurality of particles, each particle comprising a substantially interior portion comprising copper, and a substantially exterior portion comprising porous silica at least partially surrounding the interior portion, wherein the exterior portion has an inner surface defining an internal cavity and an outer surface defining at least a part of the outer portion of the antimicrobial composite material, wherein at least part of the interior portion is located in the internal cavity, wherein the average thickness from the inner surface of the exterior portion to the outer surface of the exterior portion is from about 0.01 to about 100 nm, wherein the molar ratio of the copper to the silica is about 1:1 or greater, and wherein the particles have an average size in the range of from about 400 nm to about 5 microns.

Another embodiment is an article comprising an antimicrobial composite material comprising a plurality of particles, each particle comprising a substantially interior portion comprising copper, and a substantially exterior portion comprising porous silica at least partially surrounding the interior portion, wherein the exterior portion has an inner surface defining an internal cavity and an outer surface defining at least a part of the outer portion of the antimicrobial composite material, wherein at least part of the interior portion is located in the internal cavity, wherein the average thickness from the inner surface of the exterior portion to the outer surface of the exterior portion is from about 0.01 to about 100 nm, wherein the molar ratio of the copper to the silica is about 1:1 or greater, and wherein the particles have an average size in the range of from about 400 nm to about 5 microns.

Another embodiment is a coating comprising an antimicrobial composite material comprising a plurality of particles, each particle comprising a substantially interior portion comprising copper, and a substantially exterior portion comprising porous silica at least partially surrounding the interior portion, wherein the exterior portion has an inner surface defining an internal cavity and an outer surface defining at least a part of the outer portion of the antimicrobial composite material, wherein at least part of the interior portion is located in the internal cavity, wherein the average thickness from the inner surface of the exterior portion to the outer surface of the exterior portion is from about 0.01 to about 100 nm, wherein the molar ratio of the interior portion to the exterior portion is about 1:1 or greater, wherein the particles have an average size in the range of from about 400 nm to about 5 microns, wherein the particles are dispersed in a polymer carrier, and wherein the coating has a log reduction of ≧1.

A further embodiment is a method comprising synthesizing an antimicrobial composite material comprising a plurality of particles, each particle comprising a substantially interior portion comprising copper, and a substantially exterior portion comprising porous silica at least partially surrounding the interior portion, wherein the exterior portion has an inner surface defining an internal cavity and an outer surface defining at least a part of the outer portion of the antimicrobial composite material, wherein at least part of the interior portion is located in the internal cavity, and dispersing the particles in a carrier to form the antimicrobial composite material.

Another embodiments is a method of making Cu—SiO₂ core-shell particles that are dispersed in an amphiphilic polymer matrix thus forming a composite coating that shows a good and long term antimicrobial activity. Such an antimicrobial property is achieved by a special design of materials, both the Cu based particles and the matrix polymer, from surface to interface to matrix with a self-controlled surface reconstruction mechanism that enables the controlled and continual release of active Cu particles during the lifetime application. The following steps are used to achieve the method and make the amphiphilic matrix having the Cu—SiO₂ core-shell particles dispersed throughout: synthesizing controlled (size and shape) Cu—SiO₂ core-shell particles, dispersing the Cu—SiO₂ core-shell particles in the matrix polymer, designing of surface properties of the polymer matrix for a long term activity and durability, designing of matrix properties of the polymer matrix for a continual exposure of the Cu particles over the life time, preparing and depositing of the polymer-Cu composite coating on a substrate.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A, FIG. 1B, FIG. 1C, and FIG. 1D are illustrations of particles according to some embodiments of the present disclosure.

FIG. 2 is an illustration of an article according to one embodiment.

FIGS. 3A, 3B, and 3C illustrate exemplary structures of various chemicals that can be used for surface modification and in preparing the carrier.

FIG. 4 illustrates a procedure for the synthesis of the Cu—SiO₂ core-shell particles.

FIG. 5 is an XRD pattern of the resulting Cu(I)—SiO₂ core-shell particles.

FIG. 6 is an XRD pattern of the resulting Cu—SiO₂ particles after H₂SO₄ treatment and washing.

FIG. 7 is a graph showing the particle size of the Cu—SiO₂ core shell particles obtained from micro-track.

FIG. 8 is an scanning electron microscope (SEM) image of the resulting Cu—SiO₂ particles according to one embodiment.

FIG. 9 are EDS results of exemplary Cu—SiO₂ particles.

FIG. 10 is an SEM image of exemplary Cu—SiO₂ particles obtained at pH at 4-5 and at 8-9.

FIG. 11 is a graph of the particles size distribution of exemplary Cu—SiO₂ particles obtained at pH at 4-5 and at 8-9.

FIG. 12 is an SEM showing exemplary Cu—SiO₂ particles that have a sphere-like morphology.

FIG. 13 is an SEM showing exemplary Cu—SiO₂ particles that have a sphere-like morphology.

FIG. 14 is an XRD pattern for the Cu particles obtained by the process of hydrogen reduction, which indicates that the Cu is in the form of Cu(0).

FIG. 15 is an FTIR spectra of the GPTMOS and resulting Cu—SiO₂ particles before and after surface modification.

### DETAILED DESCRIPTION

Reference will now be made in detail to various embodiments of antimicrobial composite materials and their use in coatings, examples of which are illustrated in the accompanying drawings. Whenever possible, the same reference numerals will be used throughout the drawings to refer to the same or like parts.

As used herein the term “antimicrobial” means an agent or material, or a surface containing the agent or material that will kill or inhibit the growth of microbes from at least two of families consisting of bacteria, viruses and fungi. The term as used herein does not mean it will kill or inhibit the growth of all species of microbes within such families, but that it will kill or inhibit the growth of one or more species of microbes from such families.

As used herein, the terms “Cu⁰” and “Cu(0)” are synonymous.

As used herein, the terms “Cu⁺¹” and “Cu(I)” are synonymous.

As used herein the term “Log “Reduction” or “LR” means Log(Cₐ/C₀), where Cₐ=the colony form unit (CFU) number of the antimicrobial surface containing copper ions and C₀=the colony form unit (CFU) of the control glass surface that does not contain copper ions. That is:

LR=−Log(Cₐ/C₀),

As an example, a Log Reduction of 4=99.9% of the bacteria or virus killed and a Log Reduction of 6=99.999% of bacteria or virus killed.

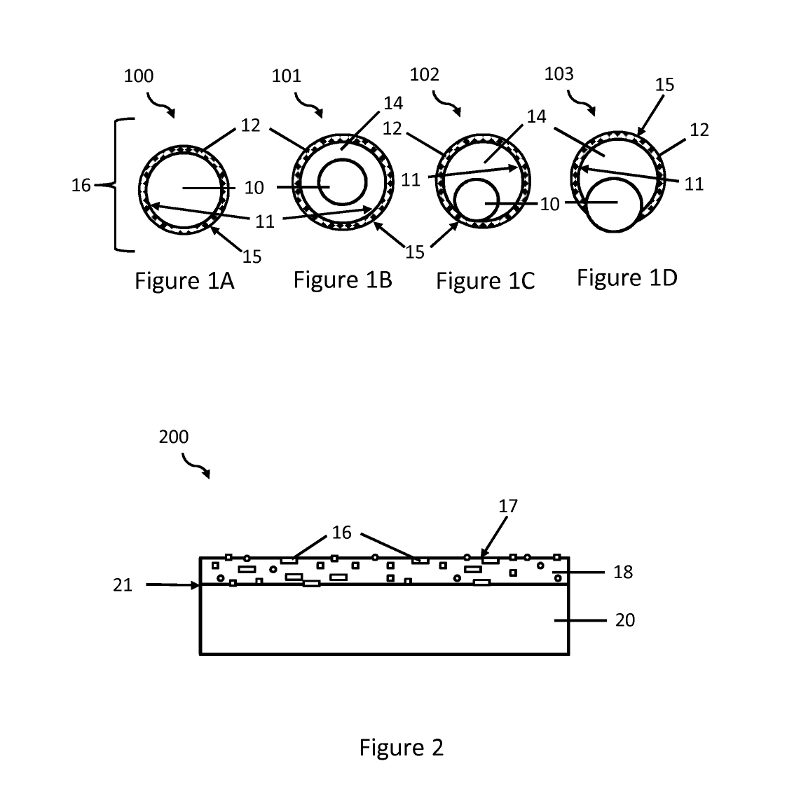

Various embodiments 100, 101, 102, 103 of particles 16, features of which are illustrated in FIG. 1A, FIG. 1B, FIG. 1C, and FIG. 1D, respectively, can be contained in an antimicrobial composite material, each particle 16 comprising: a substantially interior portion 10 comprising copper; and a substantially exterior portion 12 comprising porous silica at least partially surrounding the interior portion, wherein the exterior portion has an inner surface 11 defining an internal cavity 14 and an outer surface 15 defining at least part of the outer portion of the antimicrobial composite material, wherein at least part of the interior portion is located in the internal cavity, and wherein average thickness from the inner surface of the exterior portion to the outer surface of the exterior portion is from about 0.01 to about 100 nm, wherein the molar ratio of the copper to the silica in each particle is about 1:1 or greater, and wherein the antimicrobial composite material comprises a plurality of particles 16 having an average size in the range of from about 400 nm to about 5 microns.

Another embodiment is an antimicrobial composite material comprising a plurality of particles, the particles comprising: a substantially interior portion comprising copper, wherein at least about 10 percent by volume of the copper is Cu⁰, Cu⁺¹, or combinations thereof; and a substantially exterior portion comprising porous silica at least partially surrounding the interior portion, wherein the exterior portion has an inner surface defining an internal cavity and an outer surface defining at least a part of the outer portion of the particle, wherein at least part of the interior portion is located in the internal cavity.

The average thickness from the inner surface of the exterior portion to the outer surface of the exterior portion is from about 0.01 to about 100 nm, for example, from about 0.01 to about 99 nm, from about 0.01 to about 98 nm, from about 0.01 to about 97 nm, from about 0.01 to about 96 nm, from about 0.01 to about 95 nm, from about 0.01 to about 94 nm, from about 0.01 to about 93 nm, from about 0.01 to about 92 nm, from about 0.01 to about 91 nm, from about 0.01 to about 90 nm, from about 0.01 to about 89 nm, from about 0.01 to about 88 nm, from about 0.01 to about 87 nm, from about 0.01 to about 86 nm, from about 0.01 to about 85 nm, from about 0.01 to about 84 nm, from about 0.01 to about 83 nm, from about 0.01 to about 82 nm, from about 0.01 to about 81 nm, from about 0.01 to about 80 nm, from about 0.01 to about 79 nm, from about 0.01 to about 78 nm, from about 0.01 to about 77 nm, from about 0.01 to about 76 nm, from about 0.01 to about 75 nm, from about 0.01 to about 74 nm, from about 0.01 to about 73 nm, from about 0.01 to about 72 nm, from about 0.01 to about 71 nm, from about 0.01 to about 70 nm, from about 0.01 to about 69 nm, from about 0.01 to about 68 nm, from about 0.01 to about 67 nm, from about 0.01 to about 66 nm, from about 0.01 to about 65 nm, from about 0.01 to about 64 nm, from about 0.01 to about 63 nm, from about 0.01 to about 62 nm, from about 0.01 to about 61 nm, from about 0.01 to about 60 nm, from about 0.01 to about 59 nm, from about 0.01 to about 58 nm, from about 0.01 to about 57 nm, from about 0.01 to about 56 nm, from about 0.01 to about 55 nm, from about 0.01 to about 54 nm, from about 0.01 to about 53 nm, from about 0.01 to about 52 nm, from about 0.01 to about 51 nm, from about 0.01 to about 50 nm. In one embodiment, the average thickness from the inner surface of the exterior portion to the outer surface of the exterior portion is from about 0.01 to about 100 nm, for example, from about 0.02 to about 100 nm, from about 0.03 to about 100 nm, from about 0.04 to about 100 nm, from about 0.05 to about 100 nm, from about 0.06 to about 100 nm, from about 0.07 to about 100 nm, from about 0.08 to about 100 nm, from about 0.09 to about 100 nm, from about 0.1 to about 100 nm, from about 0.2 to about 100 nm, from about 0.3 to about 100 nm, from about 0.4 to about 100 nm, from about 0.5 to about 100 nm, from about 0.6 to about 100 nm, from about 0.7 to about 100 nm, from about 0.8 to about 100 nm, from about 0.9 to about 100 nm, from about 1 to about 100 nm, from about 2 to about 100 nm, from about 3 to about 100 nm, from about 4 to about 100 nm, from about 5 to about 100 nm, from about 6 to about 100 nm, from about 7 to about 100 nm, from about 8 to about 100 nm, from about 9 to about 100 nm, from about 10 to about 100 nm, from about 11 to about 100 nm, from about 12 to about 100 nm, from about 13 to about 100 nm, from about 14 to about 100 nm, from about 15 to about 100 nm, from about 16 to about 100 nm, from about 17 to about 100 nm, from about 18 to about 100 nm, from about 19 to about 100 nm, from about 20 to about 100 nm, from about 25 to about 100 nm, from about 26 to about 100 nm, from about 27 to about 100 nm, from about 28 to about 100 nm, from about 29 to about 100 nm, from about 30 to about 100 nm, from about 31 to about 100 nm, from about 32 to about 100 nm, from about 33 to about 100 nm, from about 34 to about 100 nm, from about 35 to about 100 nm, from about 36 to about 100 nm, from about 37 to about 100 nm, from about 38 to about 100 nm, from about 39 to about 100 nm, from about 40 to about 100 nm, from about 41 to about 100 nm, from about 42 to about 100 nm, from about 43 to about 100 nm, from about 44 to about 100 nm, from about 45 to about 100 nm, from about 46 to about 100 nm, from about 47 to about 100 nm, from about 48 to about 100 nm, from about 49 to about 100 nm, from about 50 to about 100 nm.

The metal, metal alloy, or combinations thereof can be copper, silver, palladium, platinum, gold, nickel, zinc and combinations thereof, for example, the metal can be copper or silver, or the metal alloy can be a copper alloy such as copper nickel or copper chromium. In some embodiments, at least about 10 percent by volume of the metal, metal alloy, or combinations thereof is in a reduced state. In one embodiment, when the interior portion is metal and the metal is copper, the copper is in a reduced state, for example, Cu⁰, Cu⁺¹, or combinations thereof. Copper in a reduced state provides advantaged antimicrobial activity as compared to copper in an oxidized state which may be oxidized when exposed to oxygen, for example, in air. Therefore, it may be advantageous for the copper to be in a reduced state such that Cu⁰, Cu⁺¹, or combinations thereof are present in the interior portion 10 at a percentage of at least about 10 percent by volume. When the interior portion is a metal alloy and the metal alloy is a copper alloy, it may be advantageous for the copper in the copper alloy to be in a reduced state such that Cu⁰, Cu⁺¹, or combinations thereof are present in the interior portion at a percentage of at least about 60 percent by volume of the total copper, for example, about 60 to about 100 percent, about 61 to about 100 percent, about 62 to about 100 percent, about 63 to about 100 percent, about 64 to about 100 percent, about 65 to about 100 percent, about 66 to about 100 percent, about 67 to about 100 percent, about 68 to about 100 percent, about 69 to about 100 percent, about 70 to about 100 percent, about 71 to about 100 percent, about 72 to about 100 percent, about 73 to about 100 percent, about 74 to about 100 percent, about 75 to about 100 percent, about 76 to about 100 percent, about 77 to about 100 percent, about 78 to about 100 percent, about 79 to about 100 percent, about 80 to about 100 percent, about 81 to about 100 percent, about 82 to about 100 percent, about 83 to about 100 percent, about 84 to about 100 percent, about 85 to about 100 percent, about 86 to about 100 percent, about 87 to about 100 percent, about 88 to about 100 percent, about 89 to about 100 percent, about 90 to about 100 percent, about 91 to about 100 percent, about 92 to about 100 percent, about 93 to about 100 percent, about 94 to about 100 percent, about 95 to about 100 percent. Further, the exterior portion 12 may provide protection from oxidation of the interior portion material. The exterior portion may minimize the interior portion's contact with oxygen, for example, in the air which may cause oxidation of the interior portion material.

The interior portion is substantially solid in one aspect.

The porous inorganic material of the exterior portion can be glass, glass-ceramic, ceramic, or combinations thereof. In some embodiments, the porous inorganic material is silica, titania, or a combination thereof. The exterior portion can have an average porosity in the range of from about 5 to about 50 percent by volume, for example, about 6 to about 50 percent by volume, about 7 to about 50 percent by volume, about 8 to about 50 percent by volume, about 9 to about 50 percent by volume, about 10 to about 50 percent by volume, about 11 to about 50 percent by volume, about 12 to about 50 percent by volume, about 13 to about 50 percent by volume, about 14 to about 50 percent by volume, about 15 to about 50 percent by volume, about 16 to about 50 percent by volume, about 17 to about 50 percent by volume, about 18 to about 50 percent by volume, about 19 to about 50 percent by volume, about 20 to about 50 percent by volume, about 21 to about 50 percent by volume, about 22 to about 50 percent by volume, about 23 to about 50 percent by volume, about 24 to about 50 percent by volume, about 25 to about 50 percent by volume. The porosity of the exterior portion may provide the advantage of enhanced long term efficacy of the antimicrobial effects of the interior portion material.

The particles (each a combination of the interior portion and the exterior portion) of the antimicrobial composite material, have an average size in the range of from about 100 nm to about 5 microns, for example, about 110 nm to about 5 microns, about 115 nm to about 5 microns, about 120 nm to about 5 microns, about 125 nm to about 5 microns, about 130 nm to about 5 microns, about 135 nm to about 5 microns, about 140 nm to about 5 microns, about 145 nm to about 5 microns, about 150 nm to about 5 microns, about 160 nm to about 5 microns, about 165 nm to about 5 microns, about 170 nm to about 5 microns, about 175 nm to about 5 microns, about 180 nm to about 5 microns, about 185 nm to about 5 microns, about 190 nm to about 5 microns, about 195 nm to about 5 microns, about 200 nm to about 5 microns, about 205 nm to about 5 microns, for example, about 210 nm to about 5 microns, about 215 nm to about 5 microns, about 220 nm to about 5 microns, about 225 nm to about 5 microns, about 230 nm to about 5 microns, about 235 nm to about 5 microns, about 240 nm to about 5 microns, about 245 nm to about 5 microns, about 250 nm to about 5 microns, about 260 nm to about 5 microns, about 265 nm to about 5 microns, about 270 nm to about 5 microns, about 275 nm to about 5 microns, about 280 nm to about 5 microns, about 285 nm to about 5 microns, about 290 nm to about 5 microns, about 295 nm to about 5 microns, about 300 nm to about 5 microns, about 310 nm to about 5 microns, about 315 nm to about 5 microns, about 320 nm to about 5 microns, about 325 nm to about 5 microns, about 330 nm to about 5 microns, about 335 nm to about 5 microns, about 340 nm to about 5 microns, about 345 nm to about 5 microns, about 350 nm to about 5 microns, about 360 nm to about 5 microns, about 365 nm to about 5 microns, about 370 nm to about 5 microns, about 375 nm to about 5 microns, about 380 nm to about 5 microns, about 385 nm to about 5 microns, about 390 nm to about 5 microns, about 395 nm to about 5 microns, about 400 nm to about 5 microns, about 405 nm to about 5 microns, for example, about 410 nm to about 5 microns, about 415 nm to about 5 microns, about 420 nm to about 5 microns, about 425 nm to about 5 microns, about 430 nm to about 5 microns, about 435 nm to about 5 microns, about 440 nm to about 5 microns, about 445 nm to about 5 microns, about 450 nm to about 5 microns, about 460 nm to about 5 microns, about 465 nm to about 5 microns, about 470 nm to about 5 microns, about 475 nm to about 5 microns, about 480 nm to about 5 microns, about 485 nm to about 5 microns, about 490 nm to about 5 microns, about 495 nm to about 5 microns, about 500 nm to about 5 microns. In some embodiments, the particles of the antimicrobial composite material have an average size in the range of from about 200 nm to about 5 microns, for example, about 200 nm to about 4 microns, about 200 nm to about 3 microns.

The interior portion can have an average size in the range of from about 2 nm to about 4 microns, for example, about 5 nm to about 4 microns, about 10 nm to about 4 microns, about 25 nm to about 4 microns, about 50 nm to about 4 microns, about 75 nm to about 4 microns, about 100 nm to about 4 microns, about 125 nm to about 4 microns, about 150 nm to about 4 microns, about 175 nm to about 4 microns, about 200 nm to about 4 microns, about 225 nm to about 4 microns, about 250 nm to about 4 microns, about 275 nm to about 4 microns, about 300 nm to about 4 microns, about 325 nm to about 4 microns, about 350 nm to about 4 microns, about 375 nm to about 4 microns, about 400 nm to about 4 microns, about 425 nm to about 4 microns, about 450 nm to about 4 microns, about 475 nm to about 4 microns, about 500 nm to about 4 microns, about 525 nm to about 4 microns, about 550 nm to about 4 microns, about 575 nm to about 4 microns, about 600 nm to about 4 microns, about 625 nm to about 4 microns, about 650 nm to about 4 microns, about 675 nm to about 4 microns, about 700 nm to about 4 microns, about 725 nm to about 4 microns, about 750 nm to about 4 microns, about 775 nm to about 4 microns, about 800 nm to about 4 microns, about 825 nm to about 4 microns, about 850 nm to about 4 microns, about 875 nm to about 4 microns, about 900 nm to about 4 microns, about 925 nm to about 4 microns, about 950 nm to about 4 microns, about 975 nm to about 4 microns, about 1 micron to about 4 microns. In some embodiments, the interior portion has an average size in the range of from about 200 nm to about 4 microns, for example, about 200 nm to about 3.9 microns, about 200 nm to about 3.8 microns, about 200 nm to about 3.7 microns, about 200 nm to about 3.6 microns about 200 nm to about 3.5 microns, about 200 nm to about 3.4 microns, about 200 nm to about 3.2 microns, about 200 nm to about 3.1 microns, about 200 nm to about 3.0 microns, about 200 nm to about 2.9 microns, about 200 nm to about 2.8 microns, about 200 nm to about 2.7 microns, about 200 nm to about 2.6 microns, about 200 nm to about 2.5 microns, about 200 nm to about 2.4 microns, about 200 nm to about 2.3 microns, about 200 nm to about 2.2 microns, about 200 nm to about 2.1 microns, about 200 nm to about 2.0 microns.

In some embodiments, the interior portion has an average size in the range of from about 300 nm to about 4 microns, for example, about 300 nm to about 3.9 microns, about 300 nm to about 3.8 microns, about 300 nm to about 3.7 microns, about 300 nm to about 3.6 microns about 300 nm to about 3.5 microns, about 300 nm to about 3.4 microns, about 300 nm to about 3.2 microns, about 300 nm to about 3.1 microns, about 300 nm to about 3.0 microns, about 300 nm to about 2.9 microns, about 300 nm to about 2.8 microns, about 300 nm to about 2.7 microns, about 300 nm to about 2.6 microns, about 300 nm to about 2.5 microns, about 300 nm to about 2.4 microns, about 300 nm to about 2.3 microns, about 300 nm to about 2.2 microns, about 300 nm to about 2.1 microns, about 300 nm to about 2.0 microns.

In some embodiments, the interior portion has an average size in the range of from about 400 nm to about 4 microns, for example, about 400 nm to about 3.9 microns, about 400 nm to about 3.8 microns, about 400 nm to about 3.7 microns, about 400 nm to about 3.6 microns about 400 nm to about 3.5 microns, about 400 nm to about 3.4 microns, about 400 nm to about 3.2 microns, about 400 nm to about 3.1 microns, about 400 nm to about 3.0 microns, about 400 nm to about 2.9 microns, about 400 nm to about 2.8 microns, about 400 nm to about 2.7 microns, about 400 nm to about 2.6 microns, about 400 nm to about 2.5 microns, about 400 nm to about 2.4 microns, about 400 nm to about 2.3 microns, about 400 nm to about 2.2 microns, about 400 nm to about 2.1 microns, about 400 nm to about 2.0 microns.

In some embodiments, the relative size of the interior portion to the exterior portion is such that the interior portion is smaller than the exterior portion. In some embodiments, the molar ratio of the interior portion to the exterior portion is about 1:1 or greater, for example, about 1.1:1 or greater, about 1.2:1 or greater, about 1.3:1 or greater, about 1.4:1 or greater, about 1.5:1 or greater, about 1.6:1 or greater, about 1.7:1 or greater, about 1.8:1 or greater, about 1.9:1 or greater, about 2:1 or greater, about 2.1:1 or greater, about 2.2:1 or greater, about 2.3:1 or greater, about 2.4:1 or greater, about 2.5:1 or greater, about 2.6:1 or greater, about 2.7:1 or greater, about 2.8:1 or greater, about 2.9:1 or greater, about 3.0:1 or greater, about 3.1:1 or greater, about 3.2:1 or greater, about 3.3:1 or greater, about 3.4:1 or greater, about 3.5:1 or greater, about 3.6:1 or greater, about 3.7:1 or greater, about 3.8:1 or greater, about 3.9:1 or greater, about 4:1 or greater.

The interior portion can occupy from about 20 to about 100 percent by volume of the central void, for example, about 25 to about 100 percent by volume, about 30 to about 100 percent by volume, about 35 to about 100 percent by volume, about 40 to about 100 percent by volume, about 45 to about 100 percent by volume, about 50 to about 100 percent by volume, about 55 to about 100 percent by volume, about 60 to about 100 percent by volume, about 65 to about 100 percent by volume, about 70 to about 100 percent by volume, about 75 to about 100 percent by volume, about 80 to about 100 percent by volume, about 85 to about 100 percent by volume, about 90 to about 100 percent by volume, about 95 to about 100 percent by volume. The central void can be completely filled or partially filled. The interior portion can be in physical contact with the exterior portion in one or more locations, for example, as shown in FIG. 1C and FIG. 1D, or the interior portion can be spaced from the exterior portion such as equidistant from the exterior portion, for example as shown in FIG. 1B. The interior portion can be partially protruding from the exterior portion, for example, as shown in FIG. 1D.

The exterior portion or the interior portion can be regularly shaped like a sphere, square, or polygon. The exterior portion or the interior portion can be irregularly shaped.

Another embodiment is an article comprising an antimicrobial composite material comprising a plurality of particles, each particle comprising a substantially interior portion comprising copper; and a substantially exterior portion comprising porous silica at least partially surrounding the interior portion, wherein the exterior portion has an inner surface defining an internal cavity and an outer surface defining at least a part of the outer portion of the antimicrobial composite material, wherein at least part of the interior portion is located in the internal cavity, wherein the average thickness from the inner surface of the exterior portion to the outer surface of the exterior portion is from about 0.01 to about 100 nm, wherein the molar ratio of the interior portion to the exterior portion is about 1:1 or greater, and wherein the particles have an average size in the range of from about 400 nm to about 5 microns. The features of the antimicrobial composite material, including the interior portion and the exterior portion can be as previously described.

Another embodiment is an article comprising an antimicrobial composite material comprising a plurality of particles, each particle comprising: a substantially interior portion comprising copper, wherein at least about 10 percent by volume of the copper is Cu⁰, Cu⁺¹, or combinations thereof; and a substantially exterior portion comprising silica at least partially surrounding the interior portion, wherein the exterior portion has an inner surface defining an internal cavity and an outer surface defining at least a part of the outer portion of the antimicrobial composite material, wherein at least part of the interior portion is located in the internal cavity.

In one embodiment, an example of which is illustrated in FIG. 2, the antimicrobial composite material comprises a plurality of particles 16 dispersed in a carrier 18.

The carrier can be selected from the group consisting of a polymer, a paint, an adhesive, a dispersant, and combinations thereof. In some embodiments, the carrier is amphiphilic, hydrophobic, hydrophilic, or a combination thereof. In one embodiment, the carrier is an amphiphilic polymer. The carrier can be a gas, a liquid, an aerosol, a solid, or a combination thereof.

The article can further comprise a substrate 20 onto which the antimicrobial composite material, comprising particles 16 dispersed in a carrier 18, is coated. The article can comprise a substrate 20 having at least one surface 21, wherein the antimicrobial composite material is disposed on or proximate to the at least one surface 21.

The substrate can be glass, chemically strengthened glass, glass-ceramic, ceramic, metal, wood, plastic, porcelain, or combinations thereof. The substrates or articles can be, for example, antimicrobial shelving, table tops, counter tops, tiles, walls, bedrails, and other applications in hospitals, laboratories and other institutions handling biological substances,

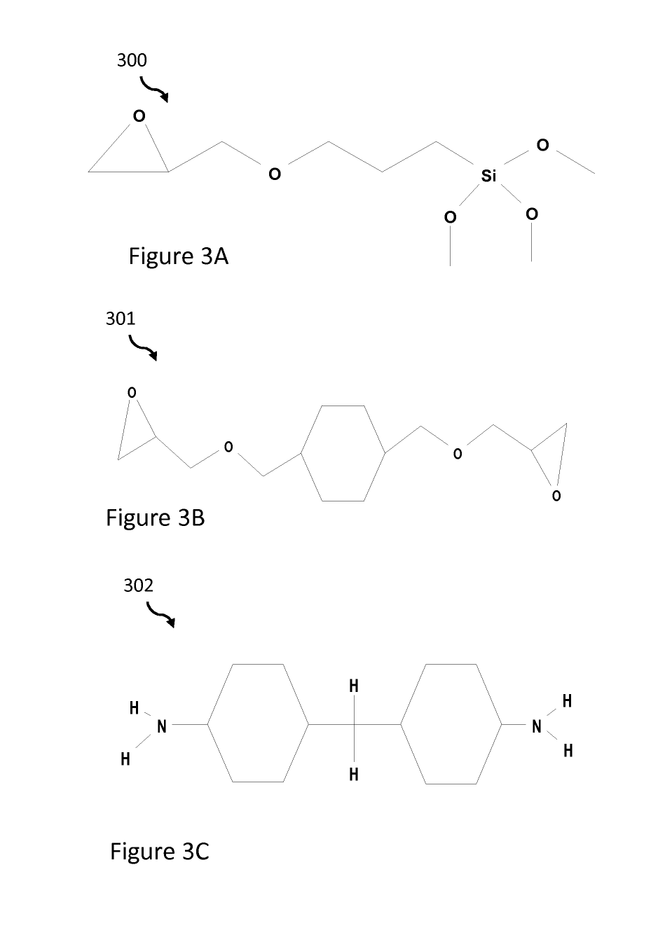

The antimicrobial composite materials, for example, antimicrobial polymer-Cu composite material, may allow for a surface reconstruction which provides both a high and a long term antimicrobial activity/capability through a doubly controlled slow release of the active Cu particles. The first controlled slow releasing mechanism can be accomplished by the structure of the Cu particles that were designed and synthesized into a substantially interior portion and a substantially exterior portion or core-shell structure or material. For example, Cu—SiO₂ core-shell particles were prepared in which the Cu core provides the antimicrobially active material and the porous SiO₂ shell functions as a barrier for the Cu core, preventing it from being directly exposed to the air/moisture but not affecting the antimicrobial activity of the Cu core. FIGS. 3A, 3B, and 3C illustrate exemplary structures of various chemicals that can be used for surface modification and in preparing the carrier, in this case, polymer which is the second controlled slow releasing mechanism can be accomplished by the. Formula 300 in FIG. 3A is 3-glycidoxypropyltrimethoxysilane (GPTMOS). Formula 301 in FIG. 3B is (GE22). Formula 302 in FIG. 3C is poly(N-acryloylmorpholine) (PACM).

One embodiment is a method of making a polymer/Cu—SiO₂ composite material coating. Based on the desired surface and matrix or carrier properties, Cu-based particles can be prepared into a core-shell structure. The Cu—SiO₂ core-shell synthesis of a polymer/Cu—SiO₂ composite material coating may have the following major steps: synthesizing Cu—SiO₂ core-shell particles having a controlled size and shape; modifying the surface of the Cu—SiO₂ core-shell particles; dispersing the Cu—SiO₂ core-shell particles in the matrix polymer; and preparing and depositing the polymer-Cu composite coating on a substrate.

A further embodiment, a method comprising synthesizing an antimicrobial composite material comprising a plurality of particles, each particle comprising a substantially interior portion comprising copper, and a substantially exterior portion comprising porous silica at least partially surrounding the interior portion, wherein the exterior portion has an inner surface defining an internal cavity and an outer surface defining at least a part of the outer portion of the antimicrobial composite material, wherein at least part of the interior portion is located in the internal cavity, and dispersing the antimicrobial composite material in a carrier.

Another embodiment is a method of making an article having a polymer/Cu—SiO₂ coating thereon, the method comprises the steps of synthesizing Cu—SiO₂ core-shell particles having a controlled size and shape; modifying the surface of the Cu—SiO₂ core-shell particles; dispersing the Cu—SiO₂ core-shell particles in the matrix polymer to form a polymer/Cu—SiO₂ coating; and depositing the polymer/Cu—SiO₂ coating on at least one surface of a provided substrate to thereby form an article having a polymer/Cu—SiO₂ coating thereon.

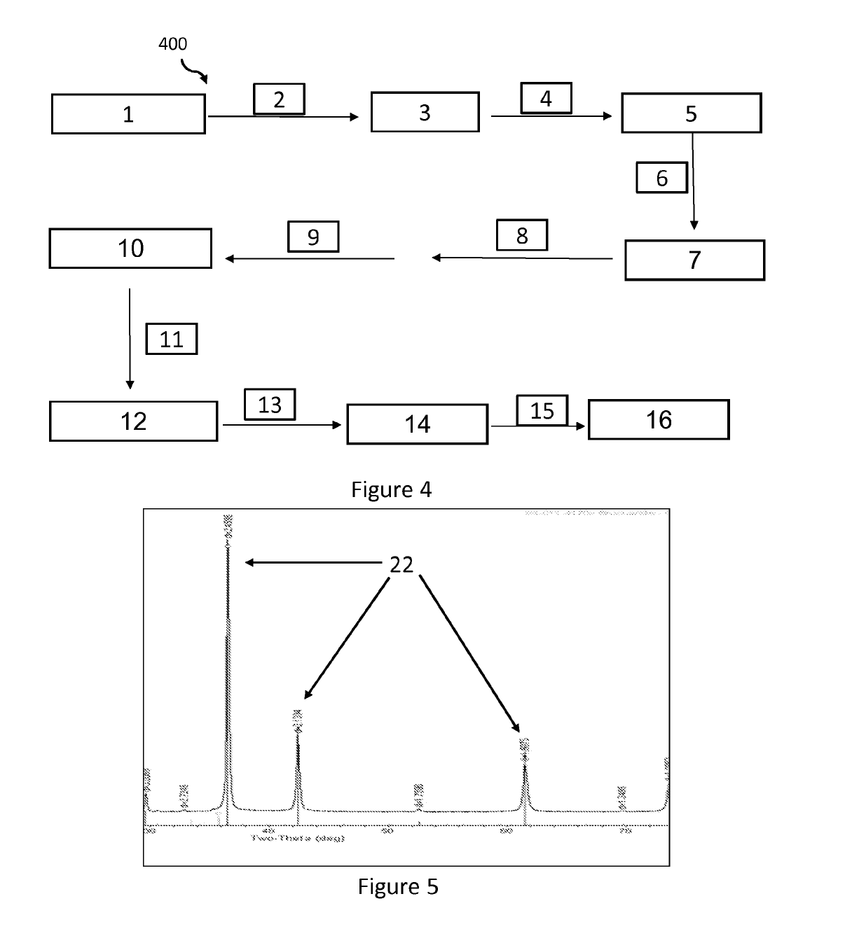

The synthesis of the Cu—SiO₂ core-shell particles is based on the method illustrated in the steps in FIG. 4. Step 1 begins with 80 mL of 0.25M Cu₂SO₄ to which is added 40 mL of 0.005M of SOA. The mixture is stirred at 80° C., Step 2, to form a dispersion, Step 3. To the dispersion is added 40 mL of 1M NaOH at 80° C. while stirring, Step 4. Cu²⁺ precipitates, Step 5. To the precipitate, 20 mL of 2.5% hydrazine hydrate is added while stirring, Step 6. This provides an in-situ reduction, Step 7. 10 mL of 0.25M Na₂SiO₃ is added at 80° C. while stirring, Step 8. To the mixture is added 1M HCl until a pH of 8-9 is reached while stirring at 80° C. for approximately 3 hrs, Step 9. This forms Cu₂O—SiO₂ core-shell particles or antimicrobial composite material, Step 10. The Cu₂O—SiO₂ core-shell particles are then filtered and washed with H₂O and dried, Step 11. The washed Cu₂O—SiO₂ core-shell particles 12 are then treated with 0.25M H₂SO₄ for 24 hrs, Step 13 to form Cu₂O—SiO₂ core-shell particles with Cu²⁺ removed 14. The Cu₂O—SiO₂ core-shell particles with Cu²⁺ removed are separated 15 into Cu₂O—SiO₂ core-shell particles with Cu⁰ 16. The method was modified to include one or more of the following steps: reducing the Cu(I) to Cu(0) in a H₂/N₂ atmosphere, changing pH of the reaction system, changing concentration of the reactants in the reaction system, or changing sequence of adding the chemicals, or other changes.

The outer surfaces of the substantially exterior portions, for example the outer surface of the shell of the Cu—SiO₂ core-shell particles can be modified. One embodiment is a method of making Cu—SiO₂ core-shell particles that are dispersed in an amphiphilic polymer matrix thus forming a composite coating that shows good and long term antimicrobial activity. Such an antimicrobial property can be achieved by a special design of materials, both the Cu—SiO₂ core-shell particles and the matrix polymer, from surface to interface to matrix with a self-controlled surface reconstruction mechanism that may enable the controlled and continual release of active Cu particles during the lifetime of the application.

In one embodiment an amphiphilic matrix has Cu—SiO₂ core-shell particles dispersed throughout the matrix and the method can comprise modifying the outer surfaces of the substantially exterior portions, for example the outer surface of the shell of the Cu—SiO₂ core-shell particles. The surfaces can be modified by introducing functional groups onto the surface of the Cu—SiO₂ core-shell particles through different chemistries. One example is introducing an epoxide group onto the surface of the resulting Cu—SiO₂ core-shell particles by using an epoxide-functionalized silane (GPTMOS) as the modification agent using sol-gel chemistry.

Cu—SiO₂ core-shell particles were dispersed in a polymer. Either surface modified or non-modified Cu—SiO₂ core-shell particles were dispersed into a carrier material, for example, polymers through a vigorous shaking and then sonicating. Water or ethanol or a combination thereof was used as the diluting agent or dispersant.

The resulting polymer/Cu—SiO₂ coating formulation was coated (through dip coating or spin coating) onto a glass substrate and cured at room temperature and at an elevated temperature (with or without presence of moisture) for a few hours to overnight. The resulting article coated with the polymer/Cu—SiO₂ coating was sent for characterization and analysis of the antimicrobial activity.

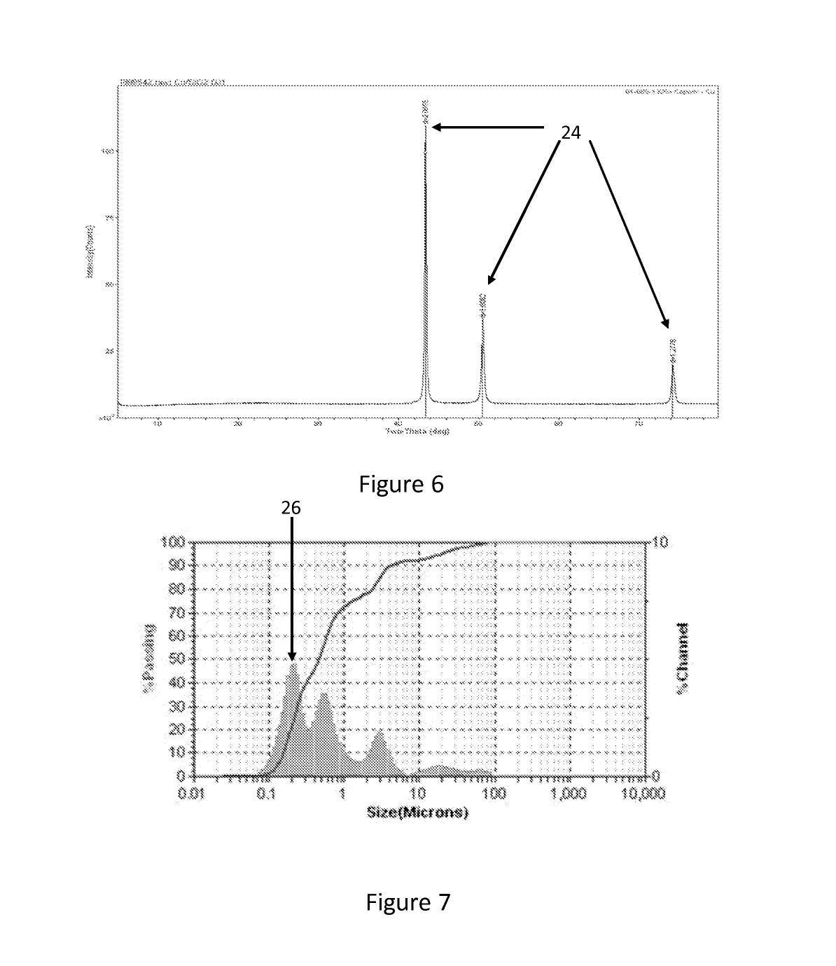

The results of the foregoing steps were that Cu—SiO₂ core-shell particles were successfully obtained. Both the Cu(0) and Cu(I) forms had a brick red color. The x-ray diffraction pattern for these particles is shown in FIG. 5, and it shows that the resulting Cu—SiO₂ core-shell particles, after reduction by hydrazine hydrate and wrapped by SiO₂, are in majority in the form of Cu(I), shown by peaks 22. However, H₂SO₄ treatment leads to a disproportional reaction of the Cu(I) to Cu(0) and Cu(II)), and washing removes the Cu(II) leaving the Cu(0) as is shown by peaks 24 in FIG. 6. FIG. 7 is a graph of the micro-track results, peak 26 showing that the preliminary particle size of the resulting Cu—SiO₂ core-shell particles is approximately 200 nm.

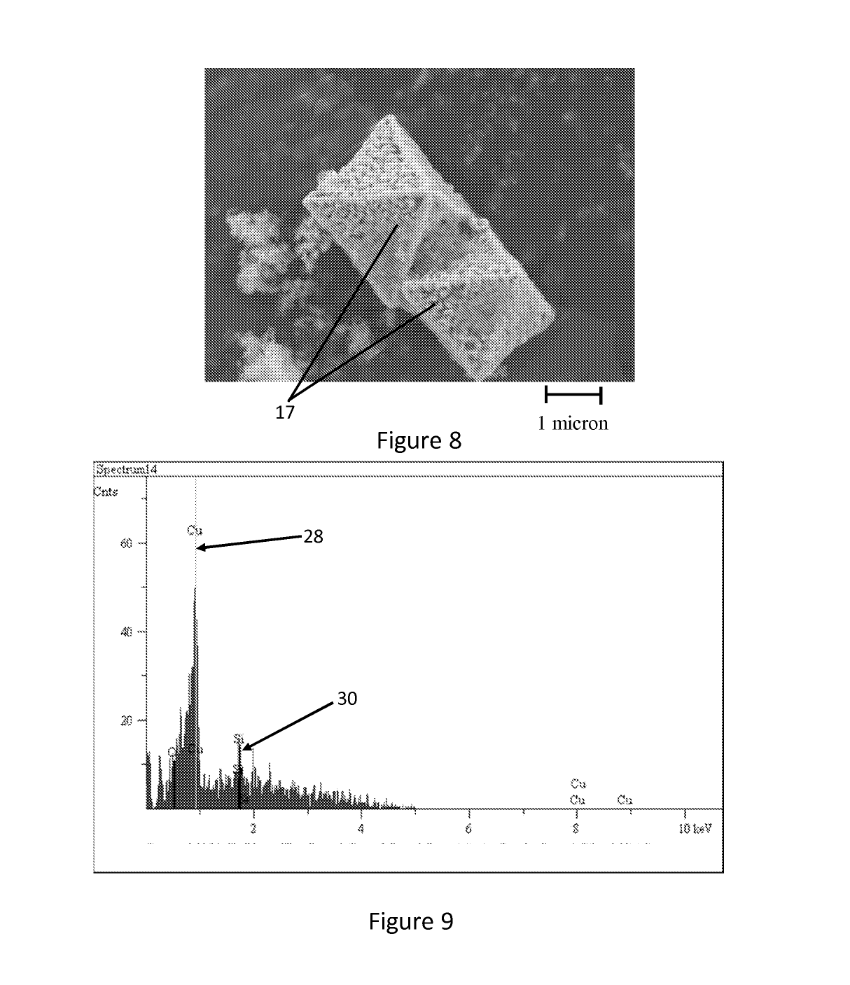

FIG. 8 is an SEM image of the resulting Cu—SiO₂ particles. The SEM shows that the Cu—SiO₂ core-shell particles 17 have an octahedral morphology in this example.

FIG. 9 is EDS results of the resulting Cu—SiO₂ particles. The EDS shows that the Cu—SiO₂ core-shell particles contain both Cu, peak 28, and Si, peak 30.

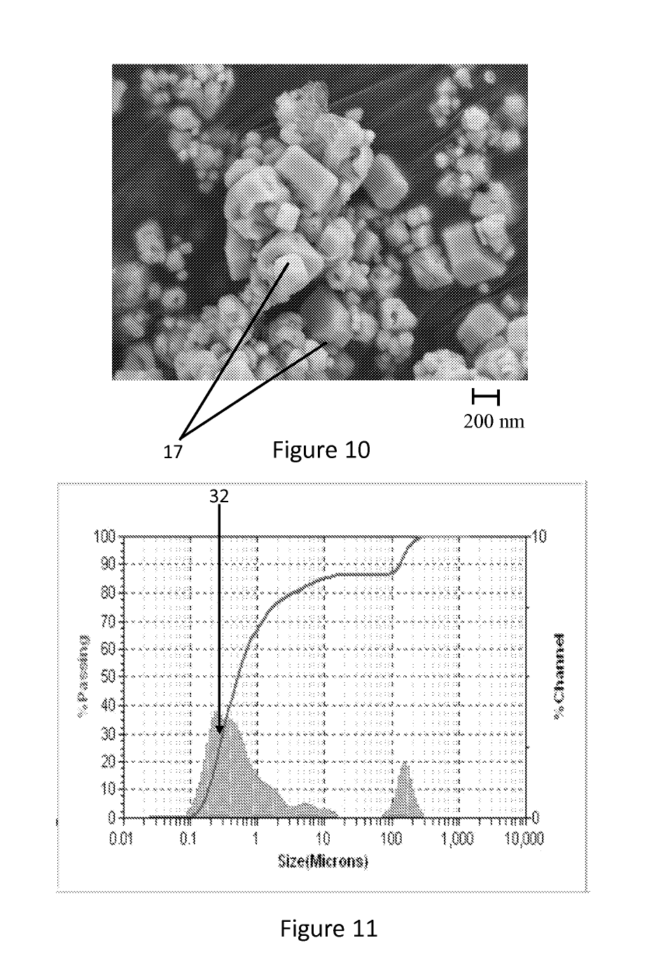

It was observed that reaction conditions, for example, the pH of the reaction system, can significantly affect the morphology of the resulting Cu—SiO₂ core-shell particles. When the pH was adjusted to be weakly acidic (pH at ˜4-5) from its very basic condition (pH at ˜14) and then to weak basic (the pH at ˜8-9), the resulting Cu—SiO₂ core-shell particles 17 show a cubic-like morphology as shown in FIG. 10, but the size of the preliminary particles remains the same as is shown in FIG. 11, peak 32.

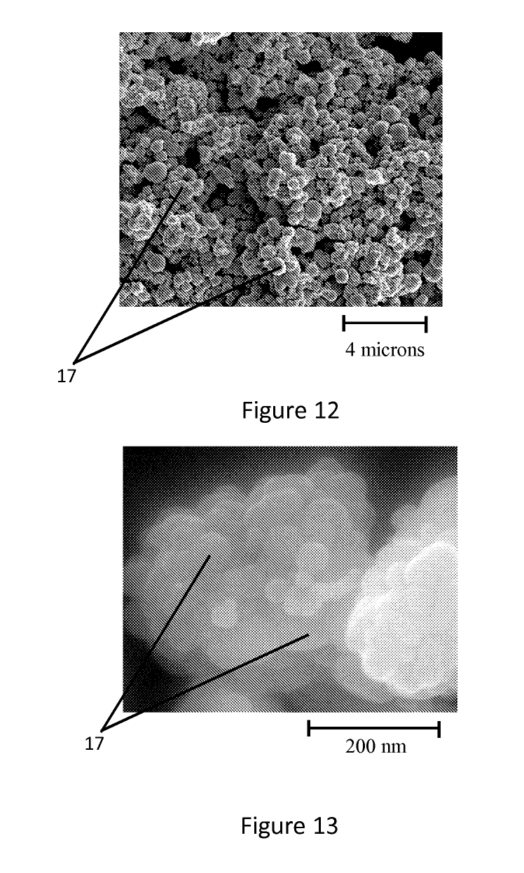

It was also determined that the concentration of the reaction system and sequence of adding the chemicals also significantly affect the morphology of the resulting Cu—SiO₂ core-shell particles, and this is seen in the SEM images in FIGS. 12 and 13 in which the Cu—SiO₂ particles 17 were obtained by: 1) diluting the concentration of the two starting materials to ⅔, and 2) hydrazine solution was added after half of the NaOH (for adjusting the pH of the step of formation of the SiO₂ shell) was added into the system (and then the remaining NaOH solution was added).

FIG. 12 shows Cu—SiO₂ particles 17 that have a sphere-like morphology, the sphere-like particle consisting of more numerous particles in the in the 10-25 nm range, FIG. 13 shows Cu—SiO₂ particles 17 that have a sphere-like morphology, that were obtained by the 33% reduced concentration and adding hydrazine into the reaction system after half of the NaOH was added.

Additional results showed that the Cu—SiO₂ particles are more stable—less sensitive to air/oxygen. The bare Cu particles became black within one week while the surface protected Cu particle, the Cu—SiO₂ core-shell particles, after 7 weeks were still in the brick red color. This indicates that the shell is protecting the Cu from oxidation.

Alcohol is a good protection agent for Cu particles. It was observed that the Cu (particularly for Cu(I)) particles in alcohol for a long period of time, such as for a couple of months, still have antimicrobial capabilities.

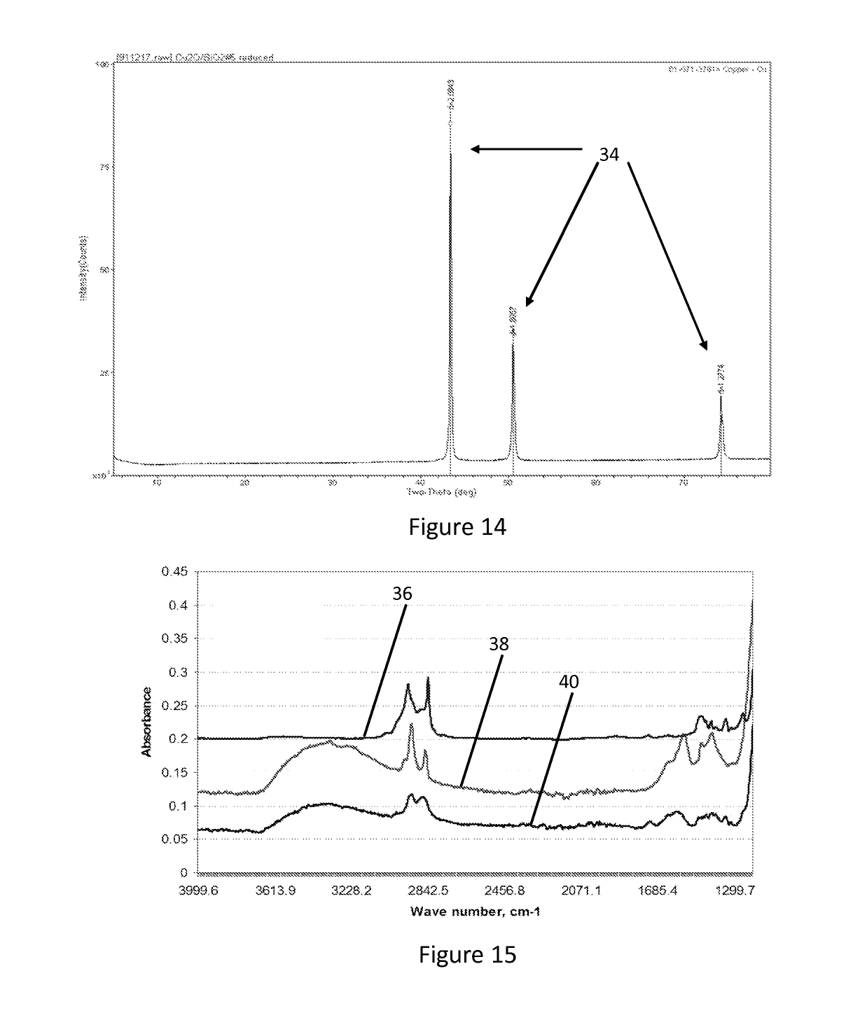

Typical methods of reducing copper, for example, Cu(I) to Cu(0) include treating the Cu(I) with H₂SO₄. A disproportional reaction occurs which wastes about 50% of the volume of the starting Cu(I)) because half of the Cu(I) turns to Cu(II) that washes away with the water in the washing step. Thus, in one embodiment, the method comprises a hydrogen reducing process. The hydrogen reducing process can comprise reducing Cu(I) to Cu(0) in a reducing atmosphere comprising hydrogen, nitrogen, or combinations thereof. The hydrogen reducing process can comprise placing the synthesized Cu(I)—SiO₂ particles in an atmosphere of H₂, N₂ or a mixture of H₂/N₂ with 6-8% H₂ (wt) at a temperature of about 300° C. to about 320° C. for 48 hours. This reducing step can maximize the transfer of the Cu(I) to Cu(0) without the about 50% loss described above. FIG. 14 shows XRD pattern for the Cu particles obtained by the process of hydrogen reduction, which indicates that the Cu is in the form of Cu(0), peaks 34.

To improve the dispersion property, the Cu—SiO₂ core-shell particles, surface modifiers were introduced organically onto the outer surfaces. In this work, the sol-gel chemistry was used for surface modification and an epoxide-functionalized silane was used as the agent of modification. The results indicate that the modification was successful. The evidence of the surface modification of the Cu—SiO₂ core-shell particles comes from two observations:
1) Ethanol suspension stabilization comparison before and after modification: Cu—SiO₂ particles, without surface modification, deposited to bottom within one hour, but remained suspended after weeks after surface modification.
2) FTIR spectra as shown in FIG. 15 indicates that the surface modified Cu—SiO₂ particles show features of the modification agent and the non-modified Cu—SiO₂ particles. Line 36 shows unmodified particles. Line 38 shows modified particles. Line 40 shows GPTMOS modified particles.

The resulting Cu—SiO₂ particles were mixed into different matrix polymers to make a polymer/Cu—SiO₂ coating on glass as the substrate. Some of the exemplary coated substrates have a red brick color.

The resulting polymer/Cu—SiO₂ coatings were tested both the antiviral and the antibacterial property. Test results showed that the resulting polymer/Cu—SiO₂ coatings possess a good and robust antiviral activity, with viral reduction after 2 hours of exposure on a polymer/Cu—SiO₂ coating reaching 98%, Log Reduction 1.62 log reduction relative to the glass control sample without the coating, for Adenovirus Type 5. In contrast to it performance on the glass substrate, the coating itself did not show antiviral activity as shown in Table 1. Table 1 shows Antiviral property of the resulting polymer/Cu—SiO₂ coatings.

TABLE 1

| | | Log |
|---|---|---|
| Samples | Virus titer reduction % | reduction |
| Polycrylic-polymer/Cu—SiO₂ coating | 97.6 | 1.62 |
| Polycrylic control | 13.9 | 0.07 |
| Behr-polymer/Cu—SiO₂ coating | 94.02 | 1.22 |
| Behr control | 0 | 0 |

The epoxy resin based coating shows a low antiviral activity, supporting that a low reconstructing surface (a hydrophobic surface) shows a low antiviral activity.

Results also showed that the resulting polymer/Cu—SiO₂ coatings possess a good antibacterial activity as is shown in Table 2. E. coli bacterium was used as the test bacterium. Table 2 shows the antibacterial property of the resulting polymer/Cu—SiO₂ coatings.

TABLE 2

| Samples | Log reduction |
|---|---|
| Polycrylic/Cu—SiO₂ composite coating | >5 |
| Polycrylic control | 0 |

The antimicrobial polymer/Cu—SiO₂ coating has several potential applications in various places, such as hospitals and many public areas where antimicrobial property is important. Because of the nature of the Cu particles, the resulting polymer/Cu—SiO₂ coating may have the color of Cu. However, other colors, such as organic dyes or inorganic pigments, can be added to the composition, and other materials, for example, metal oxides and metal hydroxides, can also be added that will affect a color change.

The carrier material, for example, polymer matrix may have the following roles:
1) forming the coating; and
2) protecting the Cu inside the Cu—SiO₂ particles and inside the matrix from direct exposure to air/O₂.

Many polymers, hydrophilic or hydrophobic, thermoplastic or thermosetting, can also be used. Other polymers including inorganic polymers can also be used. A ready- to-use coating formulation, optically transparent, clear or colored, can be used. In one embodiment the matrix polymer is a hydrophilic polymer. In another embodiment the matrix polymer is a water removable polymer because it can be removed as thin layer when doing a cleaning, thus exposing the surface Cu particles to air.

The silica shell may have two roles:
1) preventing the Cu particles from directly exposure to air/O₂ and thus the Cu—SiO₂ core-shell particles are less sensitive to air/O₂ and more stable than the bare Cu particles; and
2) slowing down the process of Cu in functionality and hence prolonging the effectiveness of antimicrobial performance of the Cu.

The size and morphology of the Cu—SiO₂ core shell particles can be adjusted by changing reaction condition such as pH, concentration and sequence of adding the chemicals. The Cu—SiO₂ core-shell particles with a sphere-like morphology shows a property of like a liquid, in that it is more flowable than the other forms, and hence is easier to be dispersed in the matrix polymer.

Surface modification of the Cu—SiO₂ core shell particles helps in dispersing them into a carrier, for example, a polymer, a paint, an adhesive, a dispersant, or combinations thereof. In addition to the GPTMOS used in this work, many other agents can be used. Further, in addition to the glass substrate, other substrates, for example, metals, ceramics and wood, can also be used. The substrate can be organic and inorganic, depending on the process, straight or bent, curved, plate or cylinder and as well as other shapes.

The antimicrobial coatings described herein have several potential uses, for example, for use as antiviral or antibacterial or antimicrobial bed rails, tiles, walls, floors, ceilings, shelving, table tops and other applications in hospitals, laboratories and other institutions handling biological substances. The thickness of the coating can be in the range of about 0.2 mm to about 2 cm, for example, about 0.5 mm to about 52 mm depending on the particular application.

### EXAMPLES

### Example 1

### Preparation of Cu—SiO₂ Core-Shell Particle

40 ml of 0.005M sodium oleate (SOA) and 80 ml of 0.25M CuSO₄ were mixed and stirred in a water bath at 80° C. After 40 ml of 1M NaOH was added to the above mixture, 20 ml of 2.5% hydrazine hydrate was poured into the reaction system. The brick-red Cu₂O precipitate should be turned out as soon as possible. Then, 10 ml of 0.25M Na₂SiO₃ was dropped into the suspension (the mass ratio of Cu₂O to SiO₂ is 10:1), and 1M HCl was used to adjust the pH value to 8-9. The reaction time was about 3 h, and afterward the solution system was removed from the water bath and filtered. Cu₂O—SiO₂ core-shell particles were obtained by washing the as-prepared precipitates with hot distilled water several times and subsequently drying them at room temperature. In further preparation, the resultant Cu₂O—SiO₂ core-shell particles were dipped in a 0.25M H₂SO₄ solution for 24 h. Dark-purple deposits and a blue-green solution resulted. The deposits of Cu₂O—SiO₂ core-shell particles were separated from the Cu²⁺ solution by centrifugation at 4000 rpm for 5 min, and then dried under vacuum for some hours at 60° C.

A modification of the preparation conditions was performed, which can significantly influence the morphology and size of the resulting Cu—SiO₂ core-shell particles, including the pH and concentration of the reaction system and sequence of adding the chemicals, particularly the NaOH solution and the hydrazine (the reducing agent).

### Example 2

### Reduction of Cu(I) to Cu(0) at an Atmosphere of H₂/N₂ Mixture

The Cu(I)—SiO₂ particles were reduced to the Cu(0)-SiO₂ particles at a reducing oven that was heated to 300° C. under an atmosphere of H₂/N₂ mixture for 48 hours and then cooled to room temperature under the same atmosphere.

### Example 3

### Surface Modification of Cu—SiO₂ Core-Shell Particles

In a 20 ml vial was added a 0.5 g Cu—SiO₂ core-shell particles, 6 g ethanol and 0.5 g water and this is mixed well. The vial was then put into an ultrasonicater under 60° C. for hours. In order to speed up the reaction, a drop of acid (e.g., acetic acid) or a drop of base can be added into the reaction system. After reaction, the solution can be directly used to prepare the coating formulation or be centrifuged to separate the surface modified Cu—SiO₂ particles from the solution.

### Example 4

### Making Coating Composition and Antimicrobial Coating

Most polymer-antimicrobial composite material coatings were prepared from a commercial paint in this example. Into the commercial paint formulation was added a certain amount, e.g., 10%, of either surface modified or non-modified Cu—SiO₂ core-shell particles (based on the % solid) and mixed well. Water or solvent, depending on whether the paint is water based or solvent based, was used to dilute the formulation when necessary. The resulting Cu—SiO₂ core-shell containing coating formulation was then dip coated or spin coated onto a glass substrate and then cured at room temperature or an elevated temperature in the absence of moisture.

### Example 5

### Making Epoxy-Amine-Cu Composite Coating

In a 20 ml vial was added 0.6 g surface modified Cu—SiO₂ particles, 1.6 g PACM and 4.6 g GE22 and this was mixed well. 6 g of ethanol was then added and mixed well; the vial was then put into an ultrasonicater for 5-10 minutes (for degassing and further mixing). The achieved mixture solution was then applied onto a glass substrate (with a process of either a dip coating or spin coating) and cured at room temperature for a few days or at an elevated temperature such as 70° C. after ethanol was removed at room temperature.

### Example 6

### Antiviral Property Test

The antiviral test procedure was performed using a modified protocol as previously described (Klibanov A. et al Nature Protocols 2007). Briefly, Adenoviru Type 5 was diluted to approximately 10⁸ PFU/ml in Earle minimum Essential medium (EMEM). Adenovirus (10 ul) was applied to the coated glass slide for 2 h at room temperature. Virus-exposed to the slides are then collected by thorough washes with in Earle minimum Essential medium (EMEM). Washing suspension containing the viruses were then serially diluted 2-fold with sterilized PBS and 50 μl of each dilution was used to infect HeLa cells grown as a mono layer in 96 wells microplate. After 24 h, viral titer was calculated by counting the number of infected HeLa cells. Virus titer reduction was calculated as previously described (Standard test method for efficacy of sanitizers recommended for inanimate Non-food contact surfaces, E1153-03, reapproved 2010): % reduction=(number of virus surviving on the glass control−number of virus surviving on the sample glass)×100/number of virus surviving on the coated glass control.

### Example 7

### Antibacterial Property Test

Antibacterial tests were carried out using cultured gram negative E. coli; DH5 alpha-Invitrogen Catalog No. 18258012, Lot No. 7672225, rendered Kanamycin resistant through a transformation with PucI9 (Invitogen) plasmid. The bacteria culture was started using either LB Kan Broth (Teknova #L8145) or Typtic Soy Broth (Teknova #T1550). Approximately 2 μl of overnight cultured liquid bacteria suspension or a pipette tip full of bacteria were streaked from an agar plate and dispensed into a capped tube containing 2-3 ml of broth and incubated overnight at 37° C. in a shaking incubator. The next day the bacteria culture was removed from the incubator and washed twice with PBS. The optical density (OD) was measured and the cell culture was diluted to a final bacterial concentration of approximately 1×10⁵ CFU/ml. The cells were placed on the copper contained Polycrylic surface and Polycrylic surface control (1×1 inch), covered with Parafilm™ and incubated for 6 hours at 37° C. with saturated humidity. Afterward, the buffers from each surface were collected and the plates were twice washed with ice-cold PBS. For each well the buffer and wash were combined and the surface spread-plate method was used for colony counting.

The sources of the materials described herein are shown in Table 3.

TABLE 3

| Materials | Description |
|---|---|
| Glass | Gorilla ™ or Eagle ™ glass substrates |
| | (trademarks of Corning Incorporated) |
| Sodium oleate (SOA) | Aldrich; Made into a 0.005M solution |
| | for use as a dispersing agent |
| Sodium silicate, Na₂O•SiO₂ | Aldrich; Made into a |
| | 0.25M solution for use as a SiO₂ source |
| Copper sulfate, CuSO₄ | Aldrich. Made into a 0.25M solution |
| | and used as source of Cu²⁺ |
| Sodium hydroxide, Na(OH)₂ | Fisher Scientific, 1M aqueous solution |
| | for transforming Cu²⁺ into Cu(OH)₂ |
| Hydrazine hydrate, | Aldrich. Made into a 0.25 solution for |
| H₂NNH₂•H₂O | reducing Cu(OH)₂ to Cu(I)/Cu(0) |
| Polycrylic paint | Minwax Company, Water-based clear |
| | protective finish for use as a matrix |
| | polymer |

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. An antimicrobial composite material comprising a plurality of particles, each particle comprising:
a substantially interior portion comprising copper; and
a substantially exterior portion comprising porous silica at least partially surrounding the interior portion, wherein the exterior portion has an inner surface defining an internal cavity and an outer surface defining at least a part of the outer portion of the antimicrobial composite material, wherein at least part of the interior portion is located in the internal cavity, wherein the average thickness from the inner surface of the exterior portion to the outer surface of the exterior portion is from about 0.01 to about 100 nm, wherein the molar ratio of the copper to the silica is about 1:1 or greater, and wherein the particles have an average size in the range of from about 400 nm to about 5 microns.

2. The material according to claim 1, wherein the interior portion occupies from about 20 to 100 percent by volume of the internal cavity.

3. The material according to claim 1, wherein the interior portion is substantially solid.

4. The material according to claim 1, wherein the copper comprises Cu⁰, Cu⁺¹, or combinations thereof.

5. The material according to claim 4, wherein at least about 10 percent by volume of the copper is Cu⁰, Cu⁺¹, or combinations thereof.

6. The material according to claim 1, wherein the metal alloy is a copper alloy and comprises at least about 60 percent by volume Cu⁰, Cu⁺¹, or combinations thereof.

7. The material according to claim 1, wherein the particles have an average size in the range of from about 400 nm to about 2 microns.

8. The material according to claim 1, wherein the exterior portion has an average porosity in the range of from about 5 to about 50 percent by volume.

9. The material according to claim 1, wherein the interior portion has an average size in the range of from about 300 nm to about 4 microns.

10. An article comprising an antimicrobial composite material comprising a plurality of particles, each particle comprising:
a substantially interior portion comprising copper; and
a substantially exterior portion comprising porous silica at least partially surrounding the interior portion, wherein the exterior portion has an inner surface defining an internal cavity and an outer surface defining at least a part of the outer portion of the antimicrobial composite material, wherein at least part of the interior portion is located in the internal cavity, wherein the average thickness from the inner surface of the exterior portion to the outer surface of the exterior portion is from about 0.01 to about 100 nm, wherein the molar ratio of the interior portion to the exterior portion is about 1:1 or greater, and wherein the particles have an average size in the range of from about 400 nm to about 5 microns.

11. The article according to claim 10, wherein the plurality of particles is dispersed in a carrier.

12. The article according to claim 11, wherein the carrier is selected from the group consisting of a polymer, a paint, an adhesive, a dispersant, and combinations thereof.

13. The article according to claim 11, wherein the carrier is a dispersant selected from the group consisting of water, an alcohol, ethanol, and combinations thereof.

14. The article according to claim 11, further comprising a surface modifier in proximity to the outer surface of the exterior portion.

15. The article according to claim 14, wherein the modifier is an epoxide group.

16. The article according to claim 11, wherein the carrier is amphiphilic, hydrophobic, hydrophilic, or a combination thereof.

17. The article according to claim 11, wherein the carrier is an amphiphilic polymer.

18. The article according to claim 11, further comprising a substrate having at least one surface, wherein the antimicrobial composite material is disposed on or proximate to the at least one surface.

19. The article according to claim 18, wherein the substrate is selected from the group consisting of glass, chemically strengthened glass, glass-ceramic, ceramic, metal, wood, plastic, porcelain, and combinations thereof.

20. A coating comprising an antimicrobial composite material comprising a plurality of particles, each particle comprising:
a substantially interior portion comprising copper; and
a substantially exterior portion comprising porous silica at least partially surrounding the interior portion, wherein the exterior portion has an inner surface defining an internal cavity and an outer surface defining at least a part of the outer portion of the antimicrobial composite material, wherein at least part of the interior portion is located in the internal cavity,
wherein the average thickness from the inner surface of the exterior portion to the outer surface of the exterior portion is from about 0.01 to about 100 nm,
wherein the molar ratio of the interior portion to the exterior portion is about 1:1 or greater, wherein the particles have an average size in the range of from about 400 nm to about 5 microns,
wherein a the particles are dispersed in a polymer carrier, and
wherein the coating has a log reduction of ≧1.

21. The coating according to claim 20, wherein the coating has a log reduction of ≧2.

22. A method comprising:
synthesizing an antimicrobial composite material comprising a plurality of particles, each particle comprising:
a substantially interior portion comprising copper; and
a substantially exterior portion comprising porous silica at least partially surrounding the interior portion, wherein the exterior portion has an inner surface defining an internal cavity and an outer surface defining at least a part of the outer portion of the antimicrobial composite material, wherein at least part of the interior portion is located in the internal cavity; and
dispersing the particles in a carrier.

23. The method according to claim 22, further comprising modifying the outer surface of the outer portion after the synthesizing.

24. The method according to claim 22, wherein the synthesizing comprises adjusting the pH of a reaction system.

25. The method according to claim 22, further comprising reducing Cu(I) to Cu(0) in a reducing atmosphere comprising hydrogen, nitrogen, or combinations thereof.

26. The method according to claim 22, further comprising depositing the antimicrobial composite material on at least one surface of a provided substrate, to form an article having an antimicrobial coating thereon.
